(19) United States
(12) Patent Application Publication
(10) Pub. No.: US 2026/0126051 A1
(43) Pub. Date: May 7, 2026

(54) DIAGONAL IMPELLER, FAN AND VENTILATION DEVICE

(71) Applicant: GUANGDONG WELLING MOTOR MANUFACTURING CO., LTD., Foshan (CN)

(72) Inventors: Tingting JIANG, Foshan (CN); Huidong HU, Foshan (CN); Cheng QIAN, Foshan (CN); Licheng ZHENG, Foshan (CN); Fan YANG, Foshan (CN)

(21) Appl. No.: 19/435,035

(22) Filed: Dec. 29, 2025

Related U.S. Application Data
(63) Continuation of application No. PCT/CN2024/101415, filed on Jun. 25, 2024.

(30) Foreign Application Priority Data
Aug. 1, 2023 (CN) 202310960097.X

(51) Int. Cl. F04D 29/28; F04D 17/16; F04D 25/08; F04D 29/30

(52) U.S. Cl. CPC F04D 29/281; F04D 17/16; F04D 25/08; F04D 29/30

(57) ABSTRACT

Provided are a diagonal impeller, a fan and a ventilation device. The diagonal impeller includes a bottom plate, a top plate and a plurality of blades. The bottom plate is configured to be connected to a motor; the top plate is provided with an air inlet; the plurality of blades are connected between the bottom plate and the top plate and are arranged around an axis of the air inlet, and air outlets are formed between the bottom plate and the top plate; in an axial direction of the air inlet, diameters of circumferences enclosed by the blades are not equal, and an outer diameter of the base plate is smaller than an outer diameter of the top plate.

This application is a continuation application of International (PCT) Patent Application No. PCT/CN2024/101415, filed on Jun. 25, 2024, which claims priority to Chinese Patent Application No. 202310960097.X, filed on Aug. 1, 2023, the entire contents of which are incorporated herein by reference.

### TECHNICAL FIELD

The present application relates to the technical field of ventilation equipment, in particular to a diagonal impeller, a fan and a ventilation device.

### BACKGROUND

At present, fans of light commercial or commercial cabinet air conditioners may mostly adopt a forward multi-blade centrifugal impeller combined with a volute fan solution. This solution may have advantages of large air volume and low noise. However, due to flow characteristics of the forward multi-blade impeller, efficiency may be low and difficult to further improve.

If existing mature backward centrifugal, mixed-flow, or axial fans are adopted, efficiency may be higher than that of fans adopting the forward multi-blade centrifugal impeller. However, pressure rise capability of these two types of fans may be lower than that of the forward multi-blade impeller fan. In this case, a larger fan volume or a higher rotation speed may be required, which may lead to a higher noise risk. Therefore, while efficiency is improved, risks in assembly and noise may also be introduced.

### SUMMARY

The present application provides a diagonal impeller, aimed at improving efficiency and reducing noise.

The present application provides a diagonal impeller including:
a base plate connected to a drive motor;
a top plate provided with an air inlet; and
a plurality of blades connected between the base plate and the top plate and arranged around an axis of the air inlet, an air outlet being formed between the base plate and the top plate.

In some embodiments, an outer diameter D1 of the top plate and an outer diameter D2 of the base plate satisfy: 0.7≤D2/D1<1.

In some embodiments, a surface of the base plate connected to the blades is an inclined surface, and an inclination angle γ of the inclined surface satisfies: 10°<γ<40°.

In some embodiments, a surface of the top plate connected to the blades is an inclined surface, and an inclination angle δ of the inclined surface satisfies: 10°<δ<50°.

In some embodiments, in a radial direction of the air inlet, a dimension between a projection line of each blade on an axial section of the air inlet and the axis of the air inlet is gradually decreased along a direction from the top plate toward the base plate.

In some embodiments, each blade has a top edge connected to the top plate and a bottom edge connected to the base plate, and a maximum diameter D3 of a top circle enclosed by the top edges and the outer diameter D1 of the top plate satisfy: D1≥D3.

In some embodiments, a maximum diameter D4 of a bottom circle enclosed by the bottom edges and the outer diameter D2 of the base plate satisfy: D4≥D2.

In some embodiments, each of the blades has a leading edge and a trailing edge connected between the top edge and the bottom edge, and the trailing edge is located outside the leading edge and inclined toward the leading edge.

In some embodiments, the trailing edge is inclined with respect to the axis of the air inlet, and an angle α between the trailing edge and the axis of the air inlet satisfies: 0°≤α≤45°.

In some embodiments, the trailing edge includes an inclined section and an arcuate section, the arcuate section protrudes in a direction distant from the leading edge, one end of the arcuate section is connected to the inclined section and another end of the arcuate section is connected to the bottom edge.

In some embodiments, the trailing edge includes an inclined section and a toothed structure, and the toothed structure is formed on the inclined section.

The present application further provides a fan including the diagonal flow impeller as described above.

The present application further provides a ventilation device including the fan as described above.

### BRIEF DESCRIPTION OF THE DRAWINGS

In order to more clearly illustrate the technical solutions in the embodiments of the present application or in the related art, drawings used in the embodiments or in the related art will be briefly described below.

FIG. 1 is a cross-sectional view of a diagonal impeller according to some embodiments of the present application.

FIG. 2 is a schematic structural view of the diagonal impeller according to some embodiments of the present application.

FIG. 3 is a schematic structural view of the diagonal impeller according to some embodiments of the present application.

FIG. 4 is a schematic diagram of dimensions of respective structures on the diagonal impeller according to some embodiments of the present application.

FIG. 5 is a schematic diagram of a trailing edge structure in FIG. 2 according to some embodiments of the present application.

FIG. 6 is a schematic diagram of a trailing edge structure in FIG. 3 according to some embodiments of the present application.

FIG. 7 is a comparison chart of required rotation speeds of the diagonal impeller and an equal diameter impeller under a same efficiency and a same air volume according to some embodiments of the present application.

FIG. 8 is a comparison chart of efficiency of a fan using the diagonal impeller and efficiency of a fan using a traditional impeller according to some embodiments of the present application.

### DESCRIPTION OF REFERENCE SIGNS

| Reference | | Reference | |
|---|---|---|---|
| sign | Name | sign | Name |
| 10 | base plate | 33 | trailing edge |
| 20 | top plate | 331 | inclined section |
| 21 | air inlet | 332 | arcuate section |
| 30 | blade | 34 | air outlet |
| 31 | bottom edge | 40 | motor |
| 32 | leading edge | | |

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings.

It should be noted that if there is a directional indication (such as up, down, left, right, front, rear . . . ) in the embodiments of the present application, the directional indication is only used to explain the relative positional relationship, movement, etc. of the components in a certain posture (as shown in the drawings). If the specific posture changes, the directional indication will change accordingly.

In the present application, unless otherwise clearly specified and limited, the terms “connected”, “fixed”, etc. should be interpreted broadly. For example, “fixed” can be a fixed connection, a detachable connection, or a whole; can be a mechanical connection or an electrical connection; may be directly connected, or indirectly connected through an intermediate medium, and may be the internal communication between two elements or the interaction relationship between two elements, unless specifically defined otherwise. For those of ordinary skill in the art, the specific meaning of the above-mentioned terms in the present application can be understood according to specific circumstances.

It should be noted that, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. Besides, the meaning of “and/or” appearing in the present application includes three parallel scenarios. For example, “A and/or B” includes only A, or only B, or both A and B. In addition, the technical solutions between the various embodiments can be combined with each other.

The present application provides a diagonal impeller.

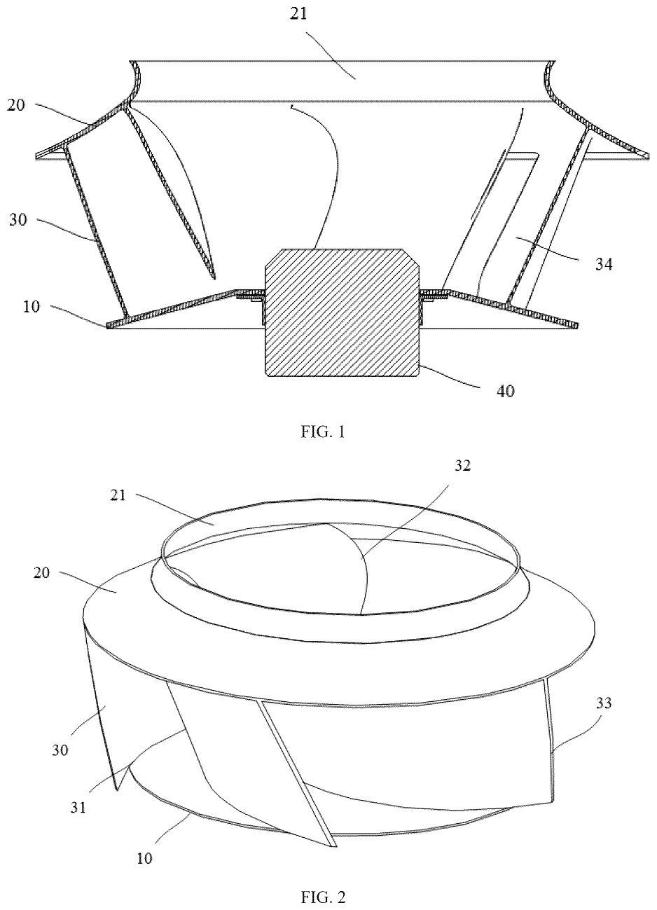

As shown in FIG. 1 to FIG. 8, in some embodiments of the present application, the diagonal impeller includes a base plate 10, a top plate 20, and a plurality of blades 30. The base plate 10 is configured to be connected to a motor 40. The top plate 20 is provided with an air inlet 21. The plurality of blades 30 are connected between the base plate 10 and the top plate 20 and arranged around an axis of the air inlet 21, and an air outlet 34 is formed between the base plate 10 and the top plate 20. In an axial direction of the air inlet 21, diameters of circumferences enclosed by the blades 30 are not equal, and an outer diameter of the base plate 10 is smaller than an outer diameter of the top plate 20, such that when the diagonal impeller is applied to a fan, under dimensional constraints of a housing of the fan, a load of the diagonal impeller can be maximized, thereby enabling a rotation speed to be reduced as much as possible while satisfying a pressure rise requirement, so as to improve noise performance, reduce losses of airflow under action of the diagonal impeller, and enhance efficiency.

Performance of the diagonal impeller is mainly reflected in air volume and noise control. The air volume and the noise level are correlated with each other. In general, a larger air volume corresponds to higher noise, a smaller air volume corresponds to lower noise, and the air volume is proportional to the rotation speed.

In some embodiments of the present application, the base plate 10 and the top plate 20 are concentrically connected, and the base plate 10 is provided with a mounting position for fixing the motor 40. A rotating shaft on the motor 40 is fixedly connected to the base plate 10. During operation, the rotating shaft drives the impeller to rotate. Since a plurality of blades 30 are arranged between the base plate 10 and the top plate 20, and the blades 30 are arranged at intervals along the axis of the air inlet 21 of the top plate 20, an air outlet 34 is formed between adjacent blades 30, facilitating airflow to enter the impeller through the air inlet 21 and to flow out through the air outlet 34 in a radial direction of the impeller under rotation of the impeller and action of the blades 30, such that pressure of the airflow is increased.

When the diagonal impeller is applied in a fan, through cooperation with a housing, airflow is converted from radial flow to flow along an axial direction of the impeller. In an axial direction of the air inlet 21, diameters of circumferences enclosed by the blades 30 are not equal. That is, based on specific structures of the blades 30, along a direction from the top plate 20 toward the base plate 10, the diameters of the circumferences can be gradually decreased, or the diameters of the circumferences can be increased first and then decreased, or the diameters of the circumferences can be decreased first and then increased. At this time, in cooperation with connection between the base plate 10 and the top plate 20, an impeller formed is a non-equal diameter impeller. With such an arrangement, rotation speed can be effectively reduced, noise performance can be improved, losses during turning can be effectively reduced, and efficiency can be enhanced.

An outer diameter of the base plate 10 is smaller than an outer diameter of the top plate 20. The top plate 20 guides airflow toward the blades 30, and the base plate 10 enables airflow to flow toward the air outlet 34 at a certain angle and to flow out through the air outlet 34. Arrangement of the angle facilitates airflow movement and is favorable for changing a flow direction when cooperating with the housing. Meanwhile, limiting the outer diameter of the top plate 20 to be larger than the outer diameter of the base plate 10 facilitates formation of a bladeless diffuser region between the top plate 20 and a wall surface of the housing, reduces ineffective work of airflow passing through the impeller, further enhances static pressure efficiency, and improves noise performance.

In the technical solution of the present application, in an axial direction of the air inlet 21, by designing diameters of circumferences enclosed by the blades 30 to be not equal, in cooperation with an arrangement that an outer diameter of the base plate 10 is smaller than an outer diameter of the top plate 20, when the diagonal impeller is applied in a fan, under dimensional constraints of a housing of the fan, a load of the diagonal impeller can be maximized, thereby, while satisfying a pressure rise requirement, enabling a rotation speed to be reduced as much as possible, effectively improving noise performance, reducing losses of airflow under action of the diagonal impeller, and enhancing efficiency.

As shown in FIG. 4, in some embodiments of the present application, an outer diameter D1 of the top plate 20 and an outer diameter D2 of the base plate 10 satisfy: 0.7≤D2/D1<1, so as to ensure that the outer diameter of the top plate 20 is larger than the outer diameter of the base plate 10, and to reduce losses of airflow flowing through the impeller, thereby enhancing efficiency. In some embodiments, when D2/D1 is less than 0.7, taking the outer diameter of the top plate 20 as a fixed value as an example, the outer diameter of the base plate 10 is too small, resulting in airflow not performing work through the impeller, or only a small portion of airflow performing work under action of the impeller, thereby leading to relatively large leakage losses of airflow and reduced efficiency. When D2/D1 is greater than 1, taking the outer diameter of the top plate 20 as a fixed value as an example, the outer diameter of the base plate 10 is too large, resulting in the outer diameter of the top plate 20 being smaller than the outer diameter of the base plate 10, which easily leads to an increase in ineffective work, and additionally, turning losses during conversion of airflow from radial flow to axial flow are relatively large, thereby reducing efficiency and increasing noise.

Therefore, by limiting a ratio between the outer diameter of the top plate 20 and the outer diameter of the base plate 10 to be between 0.7 and 1, it is possible to ensure that the outer diameter of the top plate 20 is larger than the outer diameter of the base plate 10, which is favorable for formation of a diffuser region, and is also beneficial to reducing losses and increasing air volume, thereby enhancing efficiency and improving noise performance. In some embodiments, a specific ratio between the outer diameter of the top plate 20 and the outer diameter of the base plate 10 can be 0.7, 0.75, 0.8, 0.85, or 0.9.

As shown in FIG. 4, in some embodiments of the present application, a surface of the base plate 10 connected to the blades 30 is an inclined surface, and an inclination angle γ of the inclined surface satisfies: 10°<γ<40°. Through inclined arrangement of the base plate 10, an inclination angle γ is formed between the inclined surface of the base plate 10 and a radial direction of the impeller, such that after airflow performs work through the impeller, airflow flows out along a direction having a certain included angle with respect to the radial direction of the impeller. Accordingly, during a turning process in which airflow is converted from radial flow to axial flow in cooperation with the housing, a turning angle of an airflow flow direction is smaller than 90°, effectively ensuring reliable airflow flow and enhancing pressure rise capability. Meanwhile, the inclined surface assists change of the airflow flow direction, reduces turning losses, and lowers impact on efficiency. In some embodiments, when γ is smaller than 10°, due to a relatively small inclination angle of the base plate 10, an assisting effect on turning is not obvious, turning losses cannot be effectively improved, and efficiency improvement is easily affected. When γ is greater than or equal to 40°, due to a relatively large inclination angle of the base plate 10, change of the airflow flow direction is effectively assisted, thereby enhancing efficiency, but pressure rise capability of the fan is easily affected, which in turn easily increases a noise risk.

Therefore, by limiting the inclination angle γ to be between 10° and 40°, losses can be reduced and efficiency can be enhanced, while ensuring that the fan has good pressure rise capability. In some embodiments, a specific value of the inclination angle γ can be 15°, 20°, 25°, 30°, or 35°.

As shown in FIG. 4, in some embodiments of the present application, a surface of the top plate 20 connected to the blades 30 is an inclined surface, and an inclination angle δ of the inclined surface satisfies: 100<δ<50°. Airflow flows into the impeller through the air inlet 21 of the top plate 20. Through inclined arrangement of the top plate 20, airflow is effectively guided to flow into a region between the top plate 20 and the base plate 10, thereby accelerating airflow to reach the blades 30. Under guiding action of the blades 30 and the base plate 10, airflow flows out of the impeller through the air outlet 34 at a certain angle, effectively improving pressure rise capability and enhancing efficiency. In some embodiments, when δ is smaller than 10°, due to a relatively small inclination angle of the top plate 20, an effect of guiding airflow to the blades 30 and the base plate 10 is not obvious, and airflow easily flows out through the air outlet 34 and then re-enters the impeller through the air inlet 21 to form circulation, thereby affecting improvement of pressure rise capability. When δ is greater than or equal to 50°, due to a relatively large inclination angle of the top plate 20, the air outlet 34 is narrowed, and the outer diameter of the top plate 20 is easily smaller than the outer diameter of the base plate 10, and costs are increased and air outlet volume is reduced.

Therefore, by limiting the inclination angle δ to be between 10° and 50°, efficiency and air volume can be ensured, while ensuring that the fan has good pressure rise capability and reducing noise. In some embodiments, a specific value of the inclination angle δ can be 15°, 20°, 25°, 30°, 35°, 40°, or 45°.

As shown in FIG. 1 to FIG. 6, in some embodiments of the present application, in a radial direction of the air inlet 21, a dimension between a projection line of each blade 30 on an axial section of the air inlet 21 and an axis of the air inlet 21 is gradually decreased along a direction from the top plate 20 toward the base plate 10. That is, along the direction from the top plate 20 toward the base plate 10, the projection line gradually approaches the axis of the air inlet 21, or diameters of circumferences enclosed by the blades 30 are gradually decreased. At this time, in cooperation with connection between the base plate 10 and the top plate 20, an impeller formed is a non-equal diameter impeller, and with limitations that D2 is smaller than D1 and 0.7≤D2/D1<1, rotation speed can be further reliably reduced, noise performance can be improved, losses during turning can be reduced, and efficiency can be enhanced.

As shown in FIG. 4, in some embodiments, the blade 30 has a top edge connected to the top plate 20 and a bottom edge 31 connected to the base plate 10. A maximum diameter D3 of a top circle enclosed by the top edges and an outer diameter D1 of the top plate 20 satisfy: D1≥D3. Accordingly, in cooperation with the outer diameter of the top plate 20 being larger than the outer diameter of the base plate 10, while ensuring that a movement clearance is reserved between the impeller and the housing without affecting rotation of the impeller, the outer diameter of the top plate 20 can be made as large as possible. At this time, a bladeless diffuser region is formed between the top plate 20 and a wall surface of the housing, which is favorable for forming secondary sealing between the top plate 20 and the housing, reducing airflow flowing out through the air outlet 34 from re-entering the impeller to perform work, and promoting airflow, under guiding action of the blades 30 and the base plate 10, to flow out along a direction having a certain included angle with respect to a radial direction of the impeller. Accordingly, in cooperation with the housing, airflow is converted from flowing along the radial direction to flowing along an axial direction, further enhancing static pressure efficiency and improving noise performance.

As shown in FIG. 4 to FIG. 5, in some embodiments, a maximum diameter D4 of a bottom circle enclosed by the bottom edges 31 and an outer diameter D2 of the base plate 10 satisfy: D4≥D2. In cooperation with an arrangement that diameters of circumferences enclosed by the blades 30 are gradually decreased, that is, D3>D4, the outer diameter of the base plate 10 is further limited, so as to ensure reliable turning of an airflow flow direction. When D4 is greater than D2, at least part of the blades 30 extends beyond the base plate 10, which further improves a flow direction of airflow flowing along the blades 30 and ensures that airflow is not blocked by the base plate 10, thereby being favorable for reducing losses during airflow turning and enhancing efficiency.

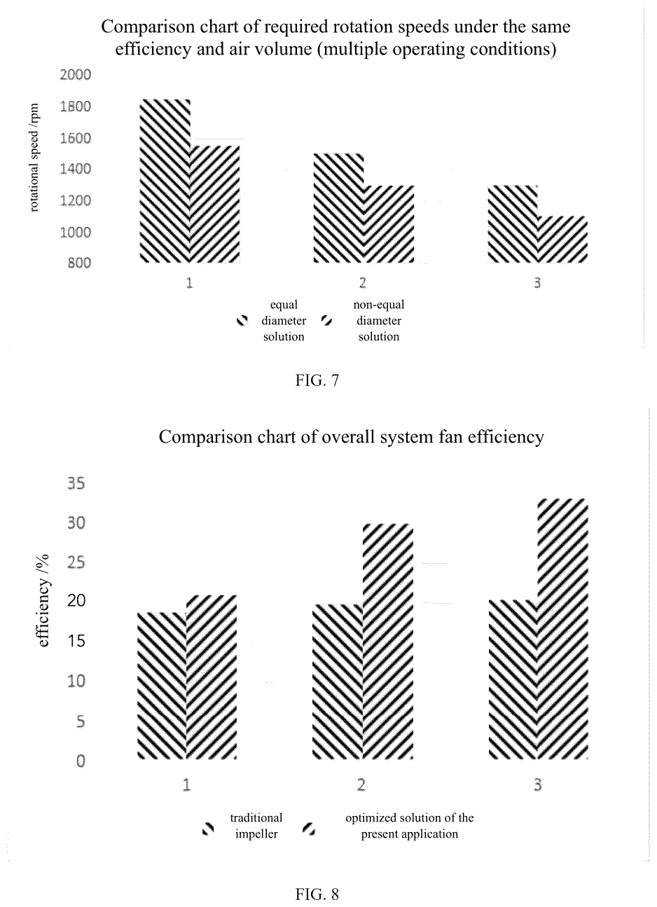

In combination with designs of D1≥D3, D4≥D2, and 0.7≤D2/D1<1, and an arrangement that, in an axial direction of the air inlet, diameters of circumferences enclosed by the blades 30 are gradually decreased, the diagonal impeller is configured as a non-equal diameter impeller. As shown in FIG. 7, under operating conditions of a same air volume and a same efficiency, a rotation speed required by the non-equal diameter impeller is significantly lower than a rotation speed required by an equal diameter impeller. Accordingly, a fan adopting the non-equal diameter impeller can effectively increase load and, while ensuring efficiency and air volume, substantially reduce rotation speed. Specific rotation speed value comparison can be referred to in the following table.

Rotation speed/rpm

| No. | Equal diameter solution | Non-equal diameter solution |
|---|---|---|
| 1 | 1850 | 1550 |
| 2 | 1500 | 1300 |
| 3 | 1300 | 1100 |

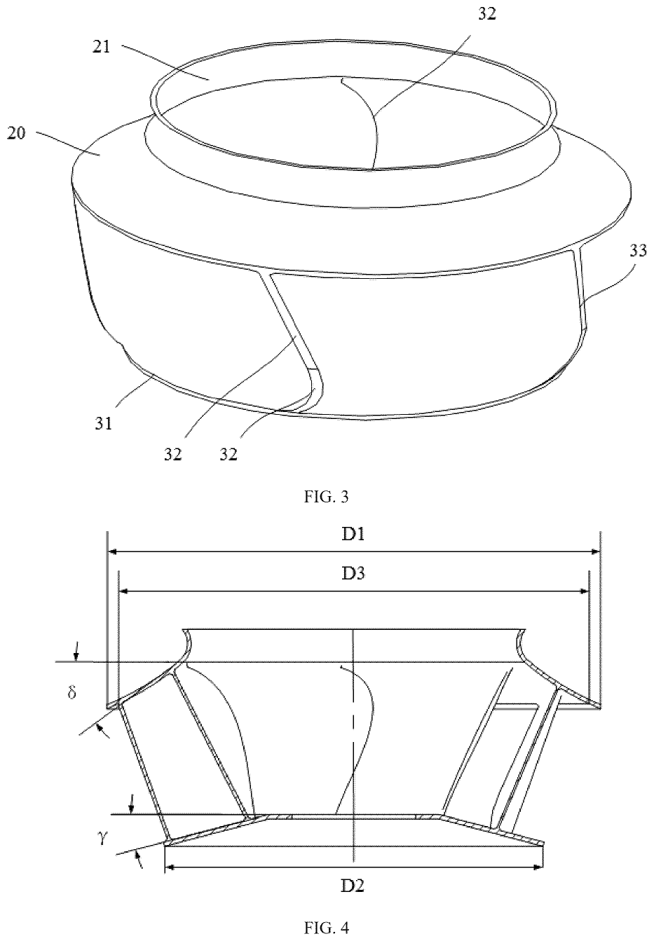

As shown in FIG. 2 to FIG. 3, in some embodiments, the blade 30 has a leading edge 32 and a trailing edge 33 connected between the top edge and the bottom edge 31. The trailing edge 33 is located outside the leading edge 32 and is inclined toward the leading edge 32. The trailing edge 33 can be entirely inclined or partially inclined. With such an arrangement, a phase difference of airflow at the air outlet 34 can be changed, so that superposition of noise energy is effectively weakened and noise is reduced.

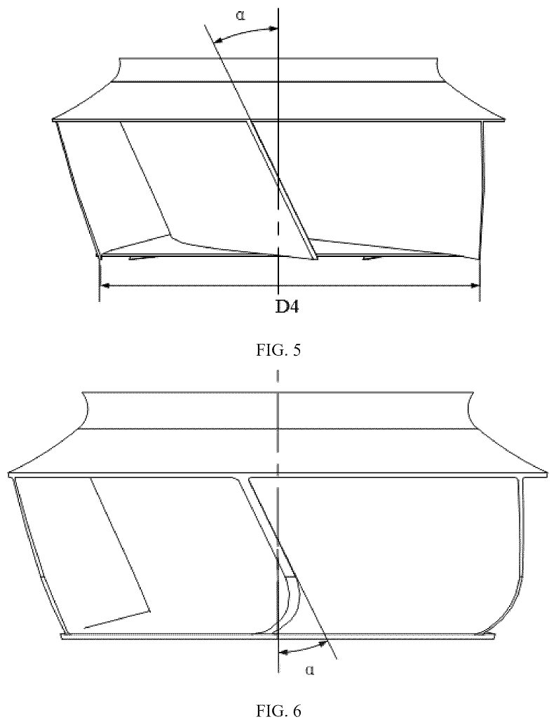

As shown in FIG. 5 to FIG. 6, in some embodiments, the trailing edge 33 is inclined relative to the axis of the air inlet 21, and an included angle between the trailing edge 33 and the axis of the air inlet 21 is α, with 0°≤α≤45°. With such an arrangement, air volume in an axial direction of the impeller presents an obvious linear change, thereby improving noise performance. In some embodiments, one end of the trailing edge 33 is connected to the top plate 20, and another end of the trailing edge 33 is gradually inclined toward the base plate 10. An included angle α is formed between an inclination direction of the trailing edge 33 and an axial direction of the air inlet 21. A specific value of the included angle α can be 5°, 10°, 15°, 20°, 25°, 30°, 35°, 40°, or 45°.

Further, in some embodiments, the trailing edge 33 includes an inclined section 331 and an arcuate section 332. The arcuate section 332 protrudes in a direction away from the leading edge 32, and one end of the arcuate section 332 is connected to the inclined section 331, and another end of the arcuate section 332 is connected to the bottom edge 31. As shown in FIG. 6, an inclination angle of the inclined section 331 is α, and the arcuate section 332 is connected between the inclined section 331 and the bottom edge 31, and smoothly transitions with the inclined section 331 and the base plate 10. Compared with an arrangement in which the trailing edge 33 is entirely inclined, arrangement of the arcuate section 332 effectively enhances structural rigidity of the blade 30 and is also beneficial to reducing turbulence caused by structural mutation.

In some embodiments, the trailing edge 33 includes an inclined section 331 and a toothed structure, and the toothed structure is formed on the inclined section 331. With such an arrangement, structural rigidity of the blade 30 is effectively enhanced.

It is worth noting that, through design of structural parameters such as shapes and dimensions of the above structures, performance of the diagonal impeller of the present application, compared with an equal diameter impeller, when applied to a fan, as shown in FIG. 8 and obtained from the following table, indicates that efficiency of a fan adopting the non-equal diameter impeller of the present application is significantly higher than efficiency of a fan in a traditional solution. Specific efficiency comparison can be referred to FIG. 8 and the following table.

Fan efficiency %

| No. | Traditional solution | The present solution |
|---|---|---|
| 1 | 18.81 | 20.98 |
| 2 | 19.81 | 29.9 |
| 3 | 20.4 | 33.1 |

The present application further provides a fan. The fan includes a diagonal impeller. A specific structure of the diagonal impeller is according to the above embodiments. Since the fan adopts all technical solutions of the above embodiments, the fan has at least all beneficial effects brought by the technical solutions of the above embodiments, which are not described again herein.

The present application further provides a ventilation device. The ventilation device includes a fan. A specific structure of the fan is according to the above embodiments. Since the ventilation device adopts all technical solutions of the above embodiments, the ventilation device has at least all beneficial effects brought by the technical solutions of the above embodiments, which are not described again herein. The ventilation device can be a heat pump, an air conditioner, or the like.

The above are only some embodiments of the present application, and are not intended to limit the scope of the present application. The equivalent structural transformations made by using the description of the application and the contents of the accompanying drawings, or direct/indirect applications in other relevant technical fields are included in the scope of the present application.

1. A diagonal impeller, comprising:
a base plate connected to a drive motor;
a top plate provided with an air inlet; and
a plurality of blades connected between the base plate and the top plate and arranged around an axis of the air inlet, an air outlet being formed between the base plate and the top plate,
wherein, in an axial direction of the air inlet, diameters of circumferences enclosed by the blades are not equal, and an outer diameter of the base plate is smaller than an outer diameter of the top plate.

2. The diagonal impeller according to claim 1, wherein an outer diameter D1 of the top plate and an outer diameter D2 of the base plate satisfy: 0.7≤D2/D1<1.

3. The diagonal impeller according to claim 1, wherein a surface of the base plate connected to the blades is an inclined surface, and an inclination angle γ of the inclined surface satisfies: 10°<γ<40°.

4. The diagonal impeller according to claim 1, wherein a surface of the top plate connected to the blades is an inclined surface, and an inclination angle δ of the inclined surface satisfies: 10°<δ<50°.

5. The diagonal impeller according to claim 1, wherein, in a radial direction of the air inlet, a dimension between a projection line of each blade on an axial section of the air inlet and the axis of the air inlet is gradually decreased along a direction from the top plate toward the base plate.

6. The diagonal impeller according to claim 5, wherein each blade of the plurality of blades has a top edge connected to the top plate and a bottom edge connected to the base plate, and a maximum diameter D3 of a top circle enclosed by the top edges and an outer diameter D1 of the top plate satisfy: D1≥D3.

7. The diagonal impeller according to claim 6, wherein a maximum diameter D4 of a bottom circle enclosed by the bottom edges and an outer diameter D2 of the base plate satisfy: D4≥D2.

8. The diagonal impeller according to claim 6, wherein each of the plurality of blades has a leading edge and a trailing edge connected between the top edge and the bottom edge, and the trailing edge is located outside the leading edge and inclined toward the leading edge.

9. The diagonal impeller according to claim 8, wherein the trailing edge is inclined with respect to the axis of the air inlet, and an angle α between the trailing edge and the axis of the air inlet satisfies: 0°≤α≤45°.

10. The diagonal impeller according to claim 8, wherein the trailing edge comprises an inclined section and an arcuate section, the arcuate section protrudes in a direction distant from the leading edge, one end of the arcuate section is connected to the inclined section and another end of the arcuate section is connected to the bottom edge.

11. The diagonal impeller according to claim 8, wherein the trailing edge comprises an inclined section and a toothed structure, and the toothed structure is formed on the inclined section.

12. A fan, comprising the diagonal impeller according to claim 1.

13. A ventilation device, comprising the fan according to claim 12.
